(19) United States
(12) Patent Application Publication
(10) Pub. No.: US 2024/0134651 A1
(43) Pub. Date: Apr. 25, 2024

(54) DOWNLOAD METHOD OF PROGRAM TO SETTLEMENT TERMINAL AND SETTLEMENT TERMINAL

(71) Applicant: NIDEC INSTRUMENTS CORPORATION, Nagano (JP)

(72) Inventor: Rryoichi YOKOMIZU, Nagano (JP)

(21) Appl. No.: 18/490,037

(22) Filed: Oct. 18, 2023

(30) Foreign Application Priority Data
Oct. 18, 2022 (JP) 2022-167613

(51) Int. Cl. G06F 9/4401

(52) U.S. Cl. CPC G06F 9/4401

(57) ABSTRACT

A download method of a program to a settlement terminal which includes a processor operated based on the program, a nonvolatile memory, a volatile memory and a touch screen and executes an on-line settlement. The download method includes a determination operation determining whether a specific operation to the touch screen is executed or not when power of the settlement terminal is turned on, a download operation in which, when the specific operation has been executed, a memory data rewriting program is downloaded from a program server to the volatile memory, and an update operation in which the processor executes the memory data rewriting program and thereby, a program to be updated is downloaded from the program server and is stored to the volatile memory and then, a program in the nonvolatile memory is rewritten by the program to be updated which is stored in the volatile memory.

### CROSS REFERENCE TO RELATED APPLICATION

The present invention claims priority under 35 U.S.C. § 119 to Japanese Application No. 2022-167613 filed Oct. 19, 2022, the entire content of which is incorporated herein by reference.

### TECHNICAL FIELD

At least an embodiment of the present invention may relate to a settlement terminal which is used in an on-line settlement or the like and, especially, may relate to a download method of a program to a settlement terminal and a settlement terminal capable of executing the download method.

### BACKGROUND

In a sales place such as a store, a settlement terminal which is connected with a settlement server through a network is used for performing an on-line settlement. A settlement terminal is, for example, structured as a so-called embedded computer apparatus having a touch screen for inputting. In an on-line settlement, an authentication medium such as a credit card, a prepaid card or a two-dimensional code is often used. Therefore, a settlement terminal may include a reader part for reading out data from an authentication medium and, in addition, may include a display or the like independently provided from a touch screen. In a settlement terminal, it is common that a minimum structure for functioning as a computer, in other words, a processor such as a CPU (Central Processing Unit) which is operated based on a program, a volatile memory such as a RAM (random-access memory), a nonvolatile memory such as a ROM (read-only memory) or a flash memory are mounted on a module board, and the module board is attached to a main board. The main board is provided with an I/O (input and output) interface for connecting with a network, a touch screen and the like.

A settlement terminal is a computer apparatus and thus, computer programs such as firmware or an OS (operating system) for operating the settlement terminal are required and these programs are written in a nonvolatile memory. In order to improve function, it is desired that a program having been already written in a settlement terminal is capable of being rewritten to a program of a new version. However, from a viewpoint of security, a settlement terminal is often structured so that a module board is unable to be detached from a main board and thus, it is difficult to directly write a program of a new version into a nonvolatile memory. Further, a capacity of a memory provided in a settlement terminal as a computer apparatus, especially, a capacity of a volatile memory is small and thus, even when an object program is going to be temporarily stored in the volatile memory for updating a program through a network, there may be a case that the entire program cannot be stored in the volatile memory. In order to solve such a problem, Japanese Patent Laid-Open No. 2002-175193 (Patent Literature 1) discloses a computer apparatus which is operated based on firmware includes a first ROM which stores firmware for activation including an activation program for activating a processor such as a CPU and a communication program for server connection, a RAM which temporarily stores data which are downloaded from a server, and a second ROM which stores control firmware which controls operations of the computer apparatus, and a program for performing erasure of the control firmware stored in the second ROM, a program for writing and control firmware of a new version are downloaded from the server. Further, in Patent Literature 1, in a case that the control firmware is to be downloaded, the control firmware is downloaded in a divided manner to be stored in the RAM, and writing is executed in parallel from the RAM to the second ROM and thereby, the control firmware having a size larger than a capacity of the RAM can be written into the second ROM.

The technique described in Patent Literature 1 is a technique which is capable of updating a program when a capacity of a volatile memory such as a RAM is small. However, in a case that the technique is applied to a settlement terminal, it is further desired to improve security.

### SUMMARY

In view of the problem described above, at least an embodiment of the present invention may advantageously provide a download method provided with sufficient security which is capable of being applied when a program is downloaded to a settlement terminal whose memory capacity, especially, a capacity of a volatile memory is small, and provide a settlement terminal which is capable of executing the download method.

According to at least an embodiment of the present invention, there may be provided a download method of a program to a settlement terminal which is configured as a computer apparatus including a processor which is operated based on the program, a nonvolatile memory, a volatile memory and a touch screen and executes an on-line settlement. The download method includes a determination operation which determines whether a specific operation to the touch screen is executed or not when power of the settlement terminal is turned on, a download operation in which, when it is determined that the specific operation has been executed, a memory data rewriting program is downloaded from a program server to the volatile memory, and an update operation in which, after the download operation, the processor executes the memory data rewriting program and thereby, a program to be updated at least a part of which is encrypted is downloaded from the program server and is stored to the volatile memory, and an encrypted portion of the program to be updated is decoded and then, a program in the nonvolatile memory is rewritten by the program to be updated which is stored in the volatile memory.

In the download method in accordance with at least an embodiment of the present invention, at least a part of a program to be updated is encrypted, and a memory data rewriting program itself for performing rewrite processing of a program in the settlement terminal including decoding processing is set as an object to be downloaded. Therefore, at a time of normal operation in the settlement terminal, at least a part of the memory data rewriting program does not exist in the settlement terminal. As a result, illegal analysis of the program to be updated and rewriting of program data in the nonvolatile memory by an illegal program can be suppressed, and security when a program in the settlement terminal is updated can be enhanced. Further, the update processing is executed only in a case that a specific operation is executed on the touch screen when a power source of the settlement terminal is turned on and thus, security can be further improved.

In the download method in accordance with an embodiment of the present invention, it is preferable that, when it is determined that the specific operation is not executed in the determination operation, the processor makes the settlement terminal normally activate based on the program in the nonvolatile memory. According to this configuration, normal activation and execution of the update processing can be selected based on whether a specific operation is executed or not when the power source of the settlement terminal is turned on, and maintainability of the settlement terminal is improved. Further, in a case that the settlement terminal is normally activated, when the settlement terminal is configured so as to communicate with a settlement server and execute on-line settlement after the settlement terminal is normally activated, operability of the settlement terminal is improved. In the network with which the settlement terminal is connected, it may be configured that the program server and the settlement server are independently provided. When these servers are independently provided, server operation organizations can be separated, for example, the program server is operated by a manufacturer of the settlement terminal and the settlement server is operated by a settlement business operator.

In the download method in accordance with an embodiment of the present invention, it may be configured that, when the power source is turned on, a first boot loader stored in a nonvolatile storage part which is built in the processor is activated, and the first boot loader activates a second boot loader stored in the nonvolatile memory, and the determination operation and the download operation are executed by the second boot loader. According to this configuration, complicated processing including activation of a program for a normal operation can be performed by a boot rotor, and a limit of a program size in a program for executing the determination operation and the download operation is reduced.

In the download method in accordance with an embodiment of the present invention, it may be configured that, in the update operation, the program to be updated is divided into a plurality of rewrite data and the rewrite data for one time are downloaded and stored in the volatile memory, the program in the nonvolatile memory is rewritten by the rewrite data for one time having been stored in the volatile memory, and rewriting of the rewrite data for one time is repeated until the program in the nonvolatile memory is rewritten by the entire program to be updated. According to this configuration, even when a capacity of the volatile memory is small in comparison with a size of a program to be updated, update processing can be executed.

In the download method in accordance with an embodiment of the present invention, it may be configured that the settlement terminal is shut down or reactivated after completion of the update operation. According to this configuration, the settlement terminal can be surely operated by the updated program and, since the memory data rewriting program stored in the volatile memory is surely erased, the security is improved.

Further, according to at least an embodiment of the present invention, there may be provided a settlement terminal which is connected with a settlement server and performs an on-line settlement, and the settlement terminal includes a processor which is operated based on a program, and a nonvolatile memory, a volatile memory and a touch screen which are connected with the processor. The nonvolatile memory is stored with a boot loader which is executed by the processor after a power source of the settlement terminal is turned on, and a program necessary for executing the on-line settlement. The boot loader makes the processor execute determination processing which determines whether a specific operation to the touch screen is executed or not, download processing in which, when it is determined that the specific operation has been executed, a memory data rewriting program is downloaded from a program server to the volatile memory, and activation processing which activates the memory data rewriting program. The memory data rewriting program makes the processor execute processing in which a program to be updated at least a part of which is encrypted is downloaded from the program server and is stored to the volatile memory, processing in which an encrypted portion of the program to be updated is decoded, and processing in which the program in the nonvolatile memory is rewritten by the program to be updated which is stored in the volatile memory.

In the settlement terminal in accordance with an embodiment of the present invention, at least a part of a program to be updated is encrypted, and a memory data rewriting program itself for performing rewrite processing of a program in the settlement terminal including decoding processing is set as an object to be downloaded. Therefore, when the settlement terminal is normally operated, at least a part of the memory data rewriting program does not exist in the settlement terminal. As a result, illegal analysis of the program to be updated and rewriting of program data in the nonvolatile memory by an illegal program can be suppressed, and security can be enhanced when a program in the settlement terminal is updated. Further, the update processing is executed only in a case that a specific operation is executed on the touch screen when a power source of the settlement terminal is turned on and thus, security can be further improved.

In the settlement terminal in accordance with an embodiment of the present invention, it is preferable that, when it is determined that the specific operation is not executed in the determination processing, the boot loader makes the processor normally activate the program in the nonvolatile memory. According to this configuration, normal activation and execution of the update processing can be selected based on whether a specific operation is executed or not when the power source of the settlement terminal is turned on, and maintainability of the settlement terminal is improved.

### Effects of the Invention

According to an embodiment of the present invention, even in the settlement terminal whose memory capacity, especially, a capacity of the volatile memory is small, the program such as firmware or an OS which is stored in the settlement terminal can be updated on-line while keeping sufficient security.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and where like elements are numbered alike in several Figures, in which:

FIG. 1 is a block diagram showing a settlement terminal in accordance with an embodiment of the present invention.

FIG. 2 is a flow chart showing an operation of a settlement terminal.

FIG. 3 is a view showing an example of an update mode shift operation.

FIG. 4 is an explanatory flow chart showing an update processing.

### DETAILED DESCRIPTION

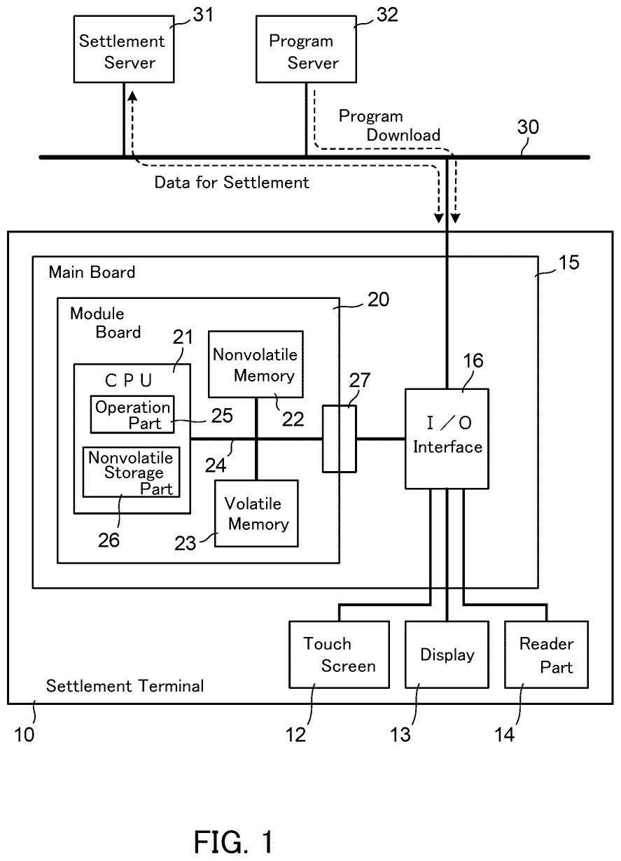

Next, an embodiment of the present invention will be described below with reference to the accompanying drawings. FIG. 1 is a block diagram showing a configuration of a settlement terminal in accordance with an embodiment of the present invention. A settlement terminal 10 shown in FIG. 1 is a terminal which is connected with a settlement server 31 through a network 30 and is used for executing an on-line settlement. The settlement terminal 10 includes a touch screen 12 which is operated by a finger of a user or the like for input, a display 13 which is independently provided from the touch screen 12 to display information to the user, and a reader part 14 for reading out data from an authentication medium. An authentication medium is, for example, a credit card, a prepaid card, or a two-dimensional code. When an authentication medium is a card medium such as a credit card or a prepaid card, the reader part 14 is structured to be a magnetic card reader or an IC (integrated circuit) card reader depending on whether the card medium is a magnetic card or an IC card. When an authentication medium is a two-dimensional code such as a QR (quick response) code (registered trademark), the reader part 14 is structured to be a camera capable of reading the two-dimensional code. A smart phone, a smart watch or the like which performs non-contact type short-range communication may be used as an authentication medium and, when such an authentication medium is used, the reader part 14 is structured so as to adapt such an authentication medium. It is preferable that the reader part 14 is structured so as to be capable of coping with a plurality of types of authentication media.

An inside of a main body of the settlement terminal 10 is provided with a main board 15, and the main board 15 is provided with an I/O interface 16 and is attached with a module board 20. The settlement terminal 10 is a computer apparatus and thus, the module board 20 is structured of a minimum configuration for functioning as a computer apparatus, in other words, structured of a CPU 21, a nonvolatile memory 22, and a volatile memory 23 which is configured of a RAM or the like to function as a main storage device connected with the CPU 21. The CPU 21 is a processor which is operated based on a program, and a microprocessor or an MPU (micro processing unit) may be used instead of the CPU 21. The nonvolatile memory 22 is configured of a rewritable ROM or a flash memory, and firmware, an OS, various application programs and the like for operating the settlement terminal 10 are stored in the nonvolatile memory 22. The nonvolatile memory 22 also functions as an external storage device in the settlement terminal as a computer apparatus. In the module board 20, the CPU 21, the nonvolatile memory 22 and the volatile memory 23 are connected with each other through an internal bus 24. The CPU 21 is configured of one chip and includes a nonvolatile storage part 26 which is a nonvolatile storage area having a small capacity in addition to an operation part 25 commonly provided in a CPU or a microprocessor.

The module board 20 is electrically connected with the main board 15 through a connection part 27 and, as a result, the internal bus 24 of the module board 20 is also electrically connected with the I/O interface 16 on the main board 15. The I/O interface 16 configures an interface for the touch screen 12, the display 13 and the reader part 14 and also functions as a network interface for the network 30. A pair of connectors is used as the connection part 27 so that the module board 20 can be detachably provided from the main board 15. However, in order to improve security in the settlement terminal 10, it is preferable that the module board 20 is soldered to the main board 15 in the connection part 27 so as not to be easily detached.

Next, an operation of the settlement terminal 10, especially, an operation at a time of power-on will be described below. The settlement terminal 10 is operated by the CPU 21 which executes the firmware and the OS stored in the nonvolatile memory 22. However, the firmware and the OS cannot be executed immediately after power is supplied, and it is required to start execution of the firmware and the OS after an environment for executing the firmware and the OS is prepared. Therefore, a program referred to as a boot loader is prepared and, first, the CPU 21 executes the boot loader. In the settlement terminal 10 shown in FIG. 1, the boot loader is divided into two portions, i.e., a first boot loader which is stored in the nonvolatile storage part 26 of the CPU 21 and a second boot loader which is stored in the nonvolatile memory 22. The first boot loader is first executed when the CPU 21 starts up after a power source is turned on or when the CPU 21 is reset, and the first boot loader executes minimum processing such as initialization of the respective memories and then activates the second boot loader. When the second boot loader is executed, the CPU 21 performs an environment setting and the like of the settlement terminal 10 and then activates the firmware and the OS. In the settlement terminal 10 in this embodiment, a program such as the firmware or the OS stored in the nonvolatile memory 22 can be updated online before activation of the firmware and the OS. Therefore, the second boot loader includes a program code for updating the firmware and the OS online. Updating a program such as a firmware or an OS online before activation of the firmware and the OS is referred to as an update processing and, among processing modes of the settlement terminal 10, a mode executing the update processing is referred to as an update mode.

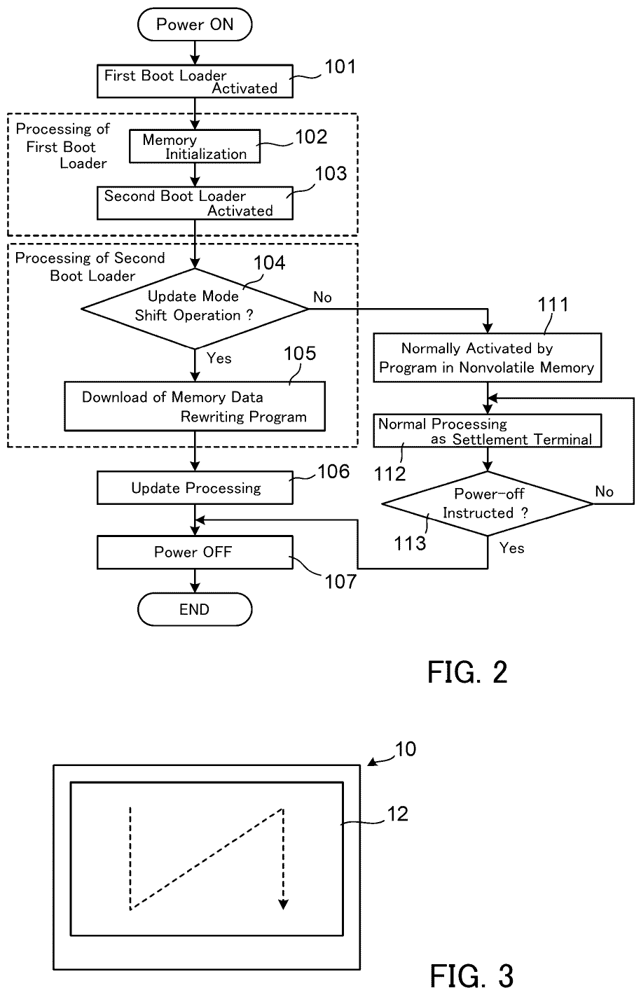

FIG. 2 is a flow chart showing an operation of the settlement terminal 10. When a power source of the settlement terminal 10 is turned on, first, in the operation 101, the first boot loader stored in the nonvolatile storage part 26 in the CPU 21 is activated. When the first boot loader is executed, the CPU 21 performs initialization of the memory in the operation 102 and then activates the second boot loader in the operation 103. In the initialization of the memory in the operation 102, the nonvolatile memory 22 and the volatile memory 23 are assigned to specific addresses in a memory space of the CPU 21 and contents of the volatile memory 23 having become indefinite due to power activation are cleared.

When the second boot loader is activated in the operation 103, the second boot loader is executed, and the CPU 21 determines whether an operation for shifting to an update mode has been performed on the settlement terminal 10 or not in the operation 104. An operation for shifting to an update mode is, for example, an operation which is not normally performed on the touch screen 12 in the settlement terminal 10, that is, an operation which is determined in advance. As an example, immediately after a power source is turned on, when a user moves his/her finger on the touch screen 12 along a path as shown in the broken line in FIG. 3, it can be determined that an operation for shifting to an update mode has been performed. Alternatively, when a specific operation such as pressing of the touch screen 12 is performed when a power source is turned on, it can be determined that an operation for shifting to an update mode has been performed. When an operation for shifting to an update mode is performed, based on the second boot loader, the CPU 21 communicates with the program server 32 on the network 30 to download a program for rewriting memory data and activate the program in the operation 105, and the processing as the second boot loader is finished. As a result, next, the CPU 21 executes update processing described below in the operation 106 and, after that, in the operation 107, the CPU 21 executes processing for turning off the power source of the settlement terminal 10. As a result, the settlement terminal 10 is set in a power-off state and a series of the processing is finished.

In the operation 104, when an operation for shifting to an update mode is not performed, after the second boot loader has finished a predetermined processing, the settlement terminal 10 is activated as usual by the firmware or the OS stored in the nonvolatile memory 22 in the operation 111, and the settlement terminal 10 is set in a state that the settlement terminal 10 is capable of transmitting and receiving settlement data with the settlement server 31 through the network 30. In this state, the CPU 21 executes normal settlement processing as the settlement terminal 10 as shown in the operation 112 and, in the operation 113, the CPU 21 determines whether power-off (in other words, shutdown) is instructed by a user or not. When power-off is not instructed, the settlement processing shown in the operation 112 is repeated. On the other hand, when power-off is instructed in the operation 113, the CPU 21 goes to the operation 107 and the processing that the power source of the settlement terminal 10 is turned off is executed.

Next, update processing will be described in detail below. In this embodiment, a program to be updated is a program which is stored in the nonvolatile memory 22 except the second boot loader. A size of a program to be updated may be larger than a capacity of the volatile memory 23 and, in this case, the volatile memory 23 is unable to store the entire program by one time download from the program server 32. Therefore, in this embodiment, a program to be updated is divided into a plurality of program data having a small size so as to be capable of being stored in the volatile memory 23 and is downloaded to the settlement terminal 10. Program data having a small size which are obtained by dividing the entire program to be updated is referred to as rewrite data. In the update processing, the rewrite data for one time are downloaded from the program server 32 and are stored in the volatile memory 23 and rewriting of the nonvolatile memory 22 is repeated by the stored rewrite data and thereby, the entire program to be updated having been stored in the nonvolatile memory 22 is rewritten to a program of a new version. Further, the settlement terminal 10 requires security and thus, a program to be updated is encrypted and the encrypted program is downloaded to the settlement terminal 10. Encryption of a program and decoding of the encrypted program require much operation time and hinder high-speed update processing of the program and thus, a part of a program to be downloaded may be encrypted instead of encryption of the entire program. In a case that the entire program to be updated is divided into a plurality of rewrite data as described above, for example, it may be configured that rewrite data which are encrypted and rewrite data which are not encrypted are alternately downloaded and thus, as a whole, about 50% of the entire program to be updated is encrypted and downloaded.

In order to realize the update processing in this embodiment, a memory data rewriting program which is downloaded to the settlement terminal 10 prior to the update processing is configured of a program portion by which rewrite data are downloaded from the program server 32 to the volatile memory 23 and stored in the volatile memory 23 and the rewrite data stored in the volatile memory 23 are transferred and written in the nonvolatile memory 22, and a program portion by which the rewrite data having been encrypted and stored in the volatile memory 23 are decoded. The memory data rewriting program is downloaded to the volatile memory 23 from the program server 32 and is executed by the CPU 21 in a developed state on the volatile memory 23.

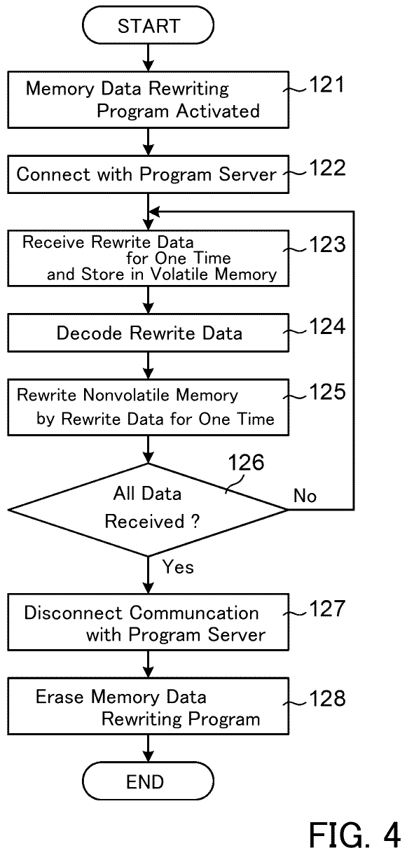

FIG. 4 is a flow chart showing the update processing. When the memory data rewriting program is downloaded to the volatile memory 23 by the second boot loader, the memory data rewriting program is activated in the operation 121. When the memory data rewriting program is executed, the CPU 21 is connected with the program server 32 by, for example, using a network address such as an IP (internet protocol) address which is previously specified in the program in the operation 122. Next, the CPU 21 receives rewrite data for one time from the program server 32 and stores them in the volatile memory 23 in the operation 123 and, in a case that the rewrite data are encrypted, the rewrite data are decoded in the operation 124. After that, in the operation 125, the CPU 21 transfers the rewrite data on the volatile memory 23 to the nonvolatile memory 22 and the program in the nonvolatile memory 22 is rewritten. Next, the CPU 21 determines whether reception of all the data of the entire program to be updated is completed or not in the operation 126 and, when there are rewrite data which are not received and not downloaded, the processing is repeated from the operation 123 for performing similar processing on the successive rewrite data. On the other hand, in a case that it is determined that all the rewrite data have been received in the operation 126, the CPU 21 disconnects communication with the program server 32 in the operation 127 and, in order to avoid abuse of the memory data rewriting program, the CPU 21 erases the memory data rewriting program stored in the volatile memory 23 in the operation 128, and the update processing is terminated. When the update processing is terminated, as shown in FIG. 2, the CPU 21 executes processing for making the settlement terminal 10 shut down (power-off) in the operation 107. In this embodiment, in a case that the settlement terminal 10 is shut down after the update processing, a restart (reactivation) which performs power-on may be performed successively after power-off.

In the update processing described above, the memory data rewriting program is only existed on the volatile memory 23 and the power is disconnected after the update processing in the operation 107 and thus, it may be configured that the memory data rewriting program is erased by power disconnection after the update processing without executing the operation 128. In a case that the program is stored in the nonvolatile memory 22 in an encrypted state and decoding is performed at a time of execution of the program, it may be configured that a program portion of the memory data rewriting program regarding the decoding is always existed in the volatile memory 23 without erasing or is stored in the nonvolatile memory 22.

In the embodiment described above, the program server 32 is, for example, capable of utilizing a server which is used in the NFS (Network File System) operated on a network. In the embodiment shown in FIG. 1, the settlement server 31 and the program server 32 are separately provided in the network 30, but the settlement server 31 and the program server 32 may be collectively configured of a single server. However, the settlement server 31 is commonly operated by a settlement business operator and a plurality of settlement servers may be provided on the network. On the other hand, a program provided from the program server 32 is assumed to be peculiar to a model of each settlement terminal 10 and it is required that a manufacturer of the settlement terminal 10 concerns with the operation and thus, it is preferable to separately provide the settlement server 31 and the program server 32.

According to the settlement terminal 10 in the embodiment described above, a program such as firmware and an OS can be updated while keeping security and without restricting a memory capacity in the settlement terminal 10.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A download method of a program to a settlement terminal which is configured as a computer apparatus including a processor which is operated based on the program, a nonvolatile memory, a volatile memory, and a touch screen and executes an on-line settlement, the download method comprising:
a determination operation which determines whether a specific operation to the touch screen is executed or not when a power source of the settlement terminal is turned on;
a download operation in which, when it is determined that the specific operation has been executed, a memory data rewriting program is downloaded from a program server to the volatile memory; and
an update operation in which, after the download operation, the processor executes the memory data rewriting program and thereby, a program to be updated at least a part of which is encrypted is downloaded from the program server and is stored to the volatile memory, and an encrypted portion of the program to be updated is decoded and then, a program in the nonvolatile memory is rewritten by the program to be updated which is stored in the volatile memory.

2. The download method according to claim 1, wherein when it is determined that the specific operation is not executed in the determination operation, the processor makes the settlement terminal normally activate based on the program in the nonvolatile memory.

3. The download method according to claim 2, wherein the settlement terminal communicates with a settlement server and executes the on-line settlement after the settlement terminal is normally activated.

4. The download method according to claim 3, wherein the program server and the settlement server are independently provided in a network with which the settlement terminal is connected.

5. The download method according to claim 1, wherein
when the power source is turned on, a first boot loader stored in a nonvolatile storage part which is built in the processor is activated, and the first boot loader activates a second boot loader stored in the nonvolatile memory, and
the determination operation and the download operation are executed by the second boot loader.

6. The download method according to claim 1, wherein
in the update operation, the program to be updated is divided into a plurality of rewrite data and the rewrite data for one time are downloaded and stored in the volatile memory,
the program in the nonvolatile memory is rewritten by the rewrite data for one time having been stored, and
rewriting of the rewrite data for one time is repeated until the program in the nonvolatile memory is rewritten by an entire program to be updated.

7. The download method according to claim 1, wherein the settlement terminal is shut down or reactivated after completion of the update operation.

8. A settlement terminal which is connected with a settlement server and performs an on-line settlement, the settlement terminal comprising:
a processor which is operated based on a program; and
a nonvolatile memory, a volatile memory and a touch screen which are connected with the processor;
wherein the nonvolatile memory is stored with a boot loader which is executed by the processor after a power source of the settlement terminal is turned on, and a program necessary for executing the on-line settlement;
the boot loader makes the processor execute:
determination processing which determines whether a specific operation to the touch screen is executed or not;
download processing in which, when it is determined that the specific operation has been executed, a memory data rewriting program is downloaded from a program server to the volatile memory; and
activation processing which activates the memory data rewriting program;
the memory data rewriting program makes the processor execute:
processing in which a program to be updated at least a part of which is encrypted is downloaded from the program server and is stored to the volatile memory;
processing in which an encrypted portion of the program to be updated is decoded; and
processing in which the program in the nonvolatile memory is rewritten by the program to be updated which is stored in the volatile memory.

9. The settlement terminal according to claim 8, wherein when it is determined that the specific operation is not executed in the determination processing, the boot loader makes the processor normally activate the program in the nonvolatile memory which is necessary for executing the on-line settlement.

10. The download method according to claim 2, wherein
when a power is turned on, a first boot loader stored in a nonvolatile storage part which is built in the processor is activated, and the first boot loader activates a second boot loader stored in the nonvolatile memory, and
the determination operation and the download operation are executed by the second boot loader.

11. The download method according to claim 2, wherein
in the update operation, the program to be updated is divided into a plurality of rewrite data and the plurality of rewrite data for one time are downloaded and stored to the volatile memory,
the program in the nonvolatile memory is rewritten by the plurality of rewrite data for one time having been stored, and
rewriting of the plurality of rewrite data for one time is repeated until the program in the nonvolatile memory is rewritten by an entire program to be updated.
